(19) United States
(12) Patent Application Publication
(10) Pub. No.: US 2006/0123929 A1
(43) Pub. Date: Jun. 15, 2006

(54) Multichannel pipette

(76) Inventors: Osma Suovaniemi, Helsinki (FI); Pertti Ekholm, Helsinki (FI)

Correspondence Address: BIRCH STEWART KOLASCH & BIRCH, PO BOX 747, FALLS CHURCH, VA, 22040-0747, US

(21) Appl. No.: 10/533,882

(22) PCT Filed: Nov. 7, 2003
(86) PCT No.: PCT/FI03/00846

§ 371 Date: May 5, 2005

(30) Foreign Application Priority Data
Nov. 8, 2002 (FI) 20022003

(51) Int. Cl. G01N 1/14; B01L 3/02

(52) U.S. Cl. 73/863.32; 73/864.17

(57) ABSTRACT

A multichannel pipette, the suction tube arrangement of which is arranged to be resilient, so that a disposable tip is attached similarly to each suction tube regardless of the shape and elastic characteristics of a tip rack. The pipette comprises a body and a plunger-cylinder system with suction tubes for each channel. Each suction tube is thus adapted to the body, that the suction tube is movable between two extreme positions in its vertical direction with respect to the body.

This invention relates to a suction device using disposable tips, especially to the construction of a pipette. The invention especially relates to a spring mechanism of the pipette's suction tube to assure an even attachment of the disposable tips in a multichannel pipette.

Pipettes are commonly used in laboratory work to dose liquids, whereby the disposable pipette tips are attached by a friction join. The tips are cone-shaped plastic items proportional to the liquid volume to be dosed. A tip is attached to the lower end of the slightly tapered suction tube of the pipette, i.e. the end cone, by inserting this into the corresponding taper of the tip. After use, the tip is removed, usually by activating a mechanism for example by the thumb, causing a downward movement of a removing means arranged around the suction tube, whereby the removing means pushes the tip apart from the suction tube.

In order to assure the compatibility of the disposable tips and the suction tube, tips should be used the dimensions and other features of which are extensively standardized. This can be achieved with reasonable certainty by always using tips from the same manufacturer, preferably from the manufacturer of the pipette. In practice, the quality and the measurement accuracy of the tips used with a given pipette vary so much that problems arise. A tip is picked up for use by inserting the end of the suction tube into a tip in a rack, without the user touching the tip, and the force used determines how well a tip attaches to the pipette.

In U.S. Pat. No. 3,853,012, a pipette is described in which a suction tube is adapted under spring tension, so that when the suction tube is pushed with a certain force towards an object, the tube acts against a spring inside the sleeve of the tip remover. Thus, the force by which the suction tube can be pushed against the upper end of a tip is delimited. Thus, the force needed to remove the tip is also delimited.

In addition a pipette usually comprises a body and a cylinder and a plunger in the body to accomplish a suction-and-blow effect, and the required push rods and springs for operating the plunger-cylinder system. In adjustable volume pipettes there is additionally a mechanism by which the stroke length of the pipette can be adjusted.

In a multichannel pipette there are several plunger-cylinder systems, i.e. channels, usually parallel, and to each cylinder a suction tube is connected. With one movement by the user, each cylinder is affected simultaneously. A multichannel pipette thus has a group of identical, parallel suction tubes to which tips can be adapted. Liquid is drawn into the tips in a single suction action, and with a sole dosing action the liquid is simultaneously dosed from the tips. Usually the target is a well row of a micro titering plate. In order to achieve an identical liquid transfer to each well on the micro titering plate, the adaptation of the pipette tips is extremely important in a multichannel pipette, especially in certain types of applications.

The significance of an even tip height is emphasized when using multichannel pipettes. The tips are usually delivered fitted in an upright position in a rack so that they can be picked up by all suction tubes of a pipette with one movement, without touching them by hand. Such a tip rack is described for example in U.S. Pat. No. 5,392,914. When picking up the tips, it is difficult to align the pipette so accurately in the vertical direction at the picking moment, that all the suction tubes of a multichannel pipette would penetrate absolutely evenly into the tips in the rack. The rack may also yield in an uneven manner. In particular, the middle tips tend to remain looser than the others, even leading to their disengagement in the middle of an important work phase.

It has been attempted to solve the problem for example by designing the tip rack to be convex so, that the upper ends of the tips in the middle protrude above those on the sides. Such a solution is described in the European Patent 1 011 863.

The object of this invention is a multichannel pipette, in which the suction tube arrangement is arranged to yield so, that a disposable tip attaches itself to each suction tube in the same way regardless of the shape and flexibility characteristics of the tip rack.

A pipette comprises a body and a plunger-cylinder system with suction tubes for each channel. Each suction tube is so adapted to the body, that the suction tube is movable in the vertical direction between two extreme positions with respect to the body. Thus, the suction tube may be pushed into the body up to an innermost position. To each suction tube is arranged a resilient member, preferably a compression spring, which holds the suction tube in a corresponding outermost position. The suction tube is provided with appropriate shoulders for fitting of the resilient member, and to hold the tube in the body.

When a suction tube row of a multichannel pipette according to the invention is brought to the upper end of a disposable tip row in a rack, each suction tube is allowed to penetrate so deep into the upper end of the tip that it yields. The spring factor is chosen to correspond to an appropriate fastening position, and because all of the suction tubes are yielding, each tip settles at the same height.

According to one embodiment of the invention, the resilient members are specifically designed for a certain type of tip to ensure an even attachment. Then the resilient members may be replaced when changing the tip type.

According to another embodiment of the invention, the resilient members are not identical in each channel of the pipette, but so designed that possible differences due to varying picking techniques are compensated. For example, the resilient members of the middle channels may have a higher spring factor than on the sides, to avoid the aforementioned imperfect attachment of the middle tips.

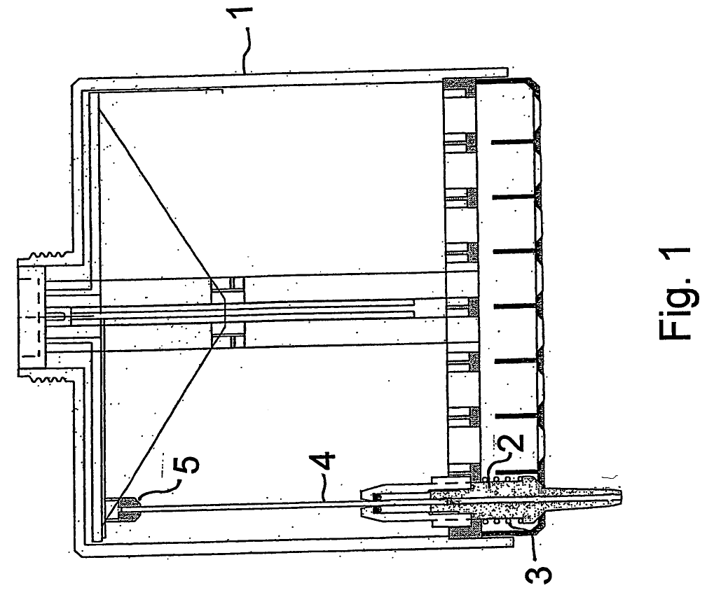

The invention is described in more detail with reference to the enclosed drawings, where FIG. 1 depicts the lower end of an 8-channel pipette. Only one of the eight identical parallel mechanisms (channels) arranged in a common body 1 is shown. The suction tube and the cylinder are parts of the same component 2, which is arranged movably in the pipette body 1 so, that a compression spring 3 holds the suction tube in an outermost position in a state of rest. A plunger 4 is movable in the cylinder 2, and the upper end of the plunger is attached to the common operation mechanism 5 of the channels. The apparatus usually comprises a tip removing mechanism, whose construction is familiar to a person skilled in the art from several prior art publications.

When picking up the tips 7 (not shown) from the rack, the user can direct the picking movement so, that each suction tube yields according to a spring 3 when a tip attaches itself to the suction tube. Then, with a high probability, each tip is attached by the same force, regardless of the small angle differences between different tips and suction tubes, Consequently, the tips also with high probability will penetrate to the same depth into the upper ends of the tips, which makes it easier to use a multichannel pipette because the lower ends of the tips will settle on the same level and each extends exactly to the bottom of a well plate.

1. A multichannel pipette comprising a body and a group of cylinder-plunger systems, whereat to each cylinder a cone-shaped suction tube is attached to which a disposable tip can be adapted, characterized in that the suction tube is arranged movably in its vertical direction with respect to the body between an outermost and an innermost position so, that with each suction tube a resilient member is arranged to force the suction tube to its outermost position.

2. A multichannel pipette according to claim 1, characterized in that the resilient member is a compression spring.

3. A multichannel pipette according to claim 1 or 2, characterized in that the resilient members in the separate channels are similar and designed for a certain disposable tip type.

4. A multichannel pipette according to claim 1 or 2, characterized in that the resilient members in different channels are different.
